(19) United States
(12) Patent Application Publication
(10) Pub. No.: US 2015/0093927 A1
(43) Pub. Date: Apr. 2, 2015

(54) ELECTRICAL CONNECTOR ASSEMBLY WITH MINIATURE AXIAL CPA

(71) Applicant: DELPHI TECHNOLOGIES, INC., Troy, MI (US)

(72) Inventors: JOHN R. MORELLO, WARREN, OH (US); JEREMY M. RICHARDSON, BUTLER, PA (US)

(21) Appl. No.: 14/041,617

(22) Filed: Sep. 30, 2013

(51) Int. Cl. H01R 13/629

(52) U.S. Cl. CPC H01R 13/62955
USPC 439/352

(57) ABSTRACT

An electrical connector assembly that includes a body, a lever, and a connector position assurance device (CPA). The lever is coupled to the body by an arm. The lever is configured to move about the arm and relative to the body to raise a lock end of the lever when a handle end of the lever is pressed. The CPA is slideably coupled to the lever to be operable between a locked position where the CPA engages with the body to prevent raising of the lock end, and an unlocked position where the lever is allowed to move about the arm. The CPA is located forward of the arm such that the CPA does not obstruct access to the handle end when the CPA is at the unlocked position.

### TECHNICAL FIELD OF INVENTION

This disclosure generally relates to a miniature electrical connector assembly, and more particularly relates to a connector position assurance device (CPA) located such that the CPA does not obstruct access to a handle end of a locking lever that is part of the assembly when the CPA is at an unlocked position.

### BACKGROUND OF INVENTION

It is known to equip an electrical connector assembly with a connector position assurance device (CPA). However, as the size of CPA equipped connectors is reduced, the CPA may interfere with bare handed (i.e. tool-less) operation of a portion of the connector assembly that actuates a locking/unlocking feature or mechanism of the connector assembly.

### SUMMARY OF THE INVENTION

In accordance with one embodiment, an electrical connector assembly is provided. The assembly includes a body, a lever, and a connector position assurance device (CPA). The lever is coupled to the body by an arm. The lever is configured to move about the arm and relative to the body to raise a lock end of the lever when a handle end of the lever is pressed. The CPA is slideably coupled to the lever. The CPA is operable between a locked position where the CPA engages with the body to prevent raising of the lock end, and an unlocked position where the lever is allowed to move about the arm. The CPA is located forward of the arm such that the CPA does not obstruct access to the handle end when the CPA is at the unlocked position.

In another embodiment, the CPA defines a notch configured to engage with a tab defined by the body to keep the CPA in the unlocked position before a mating connector is inserted into the assembly.

In yet another embodiment, the CPA additionally defines a riser configured to cooperate with a bump defined by the mating connector to disengage the notch from the tab when the mating connector is inserted into the assembly.

In accordance with one embodiment, an electrical connector assembly is provided. The assembly includes a body, a lever, and a connector position assurance device (CPA). The lever is torsionally coupled to the body. The lever is configured to rotate relative to the body to raise a lock end of the lever when a handle end of the lever is pressed. The connector position assurance device (CPA) slideably coupled to the lever. The CPA is operable between a locked position where the CPA engages with the body to prevent raising of the lock end, and an unlocked position where the lever is moveable relative to the body.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a perspective view of a connector assembly prior to insertion of a mating connector in accordance with one embodiment;

FIG. 2 is a perspective view of the connector assembly of FIG. 1 after insertion of a mating connector in accordance with one embodiment;

FIG. 3 is a sectional side view of the connector assembly with mating connector of FIG. 2 with a CPA in an unlocked position in accordance with one embodiment; and

FIG. 4 is a sectional side view of the connector assembly with mating connector of FIG. 2 with a CPA in a locked position in accordance with one embodiment.

### DETAILED DESCRIPTION

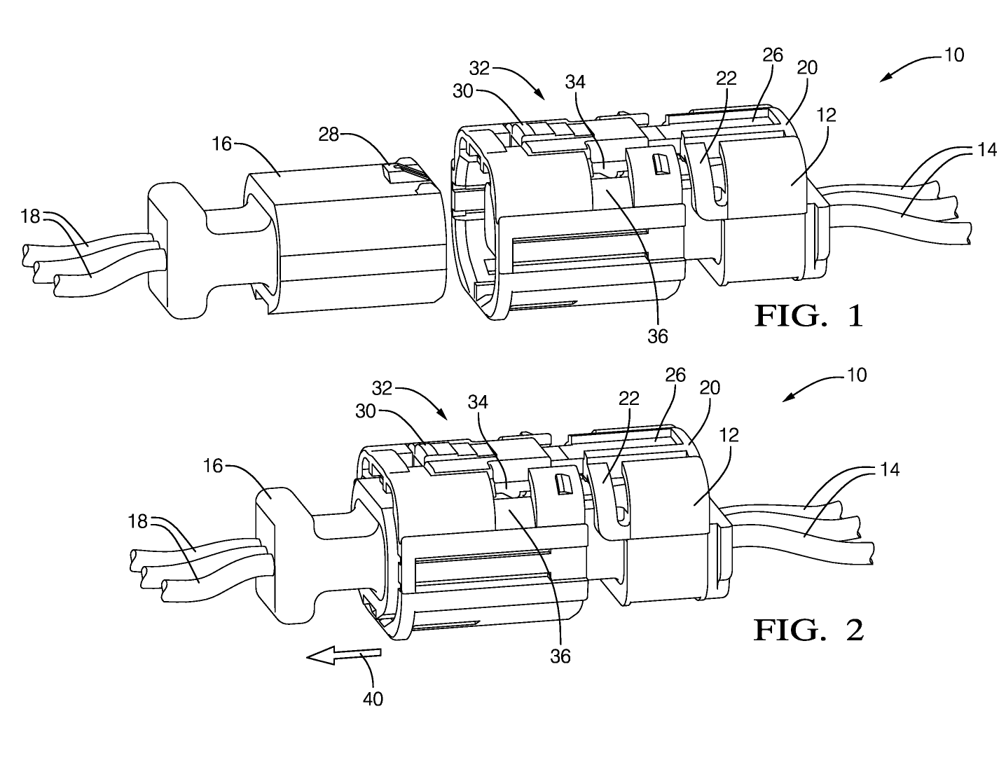

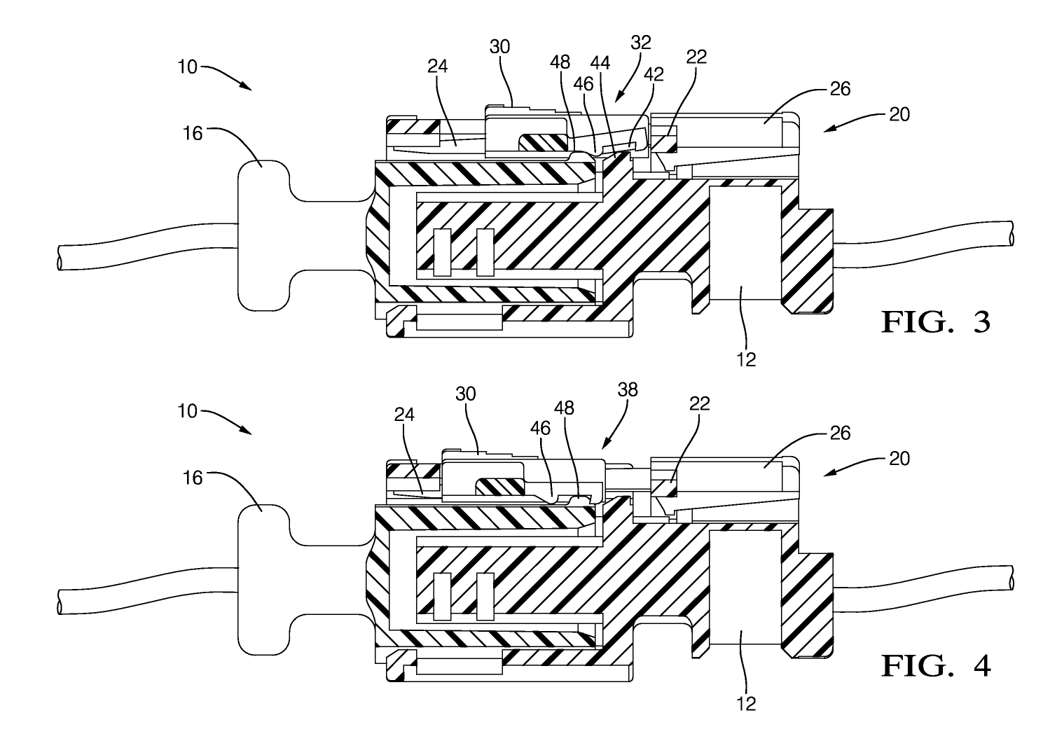

FIGS. 1 and 2 illustrate a non-limiting example of an electrical connector assembly, hereafter often referred to as the assembly 10. The outline or exterior dimensions of the connector are generally defined by a body 12 of the assembly 10. As the advantageous features of the assembly 10 described herein are generally directed to miniature connectors, non-limiting examples of the outside dimensions of the body 12 are a body length of twenty-five millimeters (25 mm) and a body diameter of ten millimeters (10 mm). When the assembly 10 is used, for example, as part of a vehicle electrical system, the assembly 10 may be attached to wires 14 of the vehicle electrical system, and connected to a mating connector 16 that is connected to other wires 18 of the vehicle electrical system. The wires are not shown in FIGS. 3 and 4 only to simplify the illustrations.

It is generally preferable for electrical connectors used in vehicle applications to have some sort of locking feature so vibration and other unexpected mechanical loads on the connectors do not lead to connectors becoming disconnected. It is also generally preferable for connectors used in vehicle applications to include features so that if the connectors must be disconnected as part of a vehicle servicing activity, the connectors can be readily disconnected by a vehicle technician without the use of special tools, or any tools for that matter.

In general, the assembly 10 includes a lever 20 that is part of a locking mechanism for the assembly 10. In this non-limiting example, the lever 20 is moveably coupled, for example torsionally coupled or flexibly coupled to the body 12 by an arm 22. The lever 20 may include a lock end 24 (FIGS. 3 and 4) and a handle end 26. Preferably, the body 12 is formed of a semi-flexible material such a polymeric compound, for example a glass filled polyester available from numerous suppliers. The arm 22 may be configured in the manner illustrated to couple the lever 20 to the body 12 so that the arm 22 torsionally pivots, enabling the lever 20 to rock, move, or rotate about the arm 22 and relative to the body 12. Preferably the arm 22 moves torsionally or rotates in such a manner as to raise the lock end 24 of the lever 20 away from a lock engaging feature 28 on the mating connector 16 when the handle end 26 of the lever 20 is pressed toward the body 12. In other words, the arm 22 is attached to a fulcrum point of the lever 20 so that the lever teeter-totters about the fulcrum point whereby the lock end 24 is raised in an upward direction when the handle end 26 is pressed in a downward direction.

As vehicle environments can be unpredictable, it may be advantageous for the assembly 10 to include a connector position assurance device (CPA), hereafter often referred to as the CPA 30. In general, CPA's are secondary or backup devices used to keep various locking mechanisms engaged and thereby help prevent inadvertent disconnection of electrical connectors. In this non-limiting example, the CPA 30 is slideably coupled to slide axially relative to the lever 20 and the body 12. FIGS. 1-3 show the CPA 30 at, or after being operated to, an unlocked position 32. While the CPA 30 is at the unlocked position 32, a wing 34 (FIGS. 1 and 2) of the CPA 30 aligns with slot 36 of the body 12 so that the lever 20 is allowed to move about the arm 22 so the lock end 24 is free to rise and thereby disengage from a lock engaging feature 28 on the mating connector 16.

The CPA 30 is also operable (i.e. slidable or moveable) to a locked position 38 (FIG. 4) where the wing 34 of the CPA 30 engages with guides (not shown) of the body 12 to prevent or resist raising of the lock end 24, and thereby prevent the mating connector 16 from being removed from the assembly 10. The CPA 30 may be formed of the same material used to form the body 12, but it is not a requirement that both parts be made of the same material.

When the CPA 30 is at the unlocked position 32, the CPA is advantageously located axially forward of the arm 22 (i.e. toward the lock end 24 relative to the arm 22) such that the CPA 30 does not obstruct access to the handle end 26 when the CPA 30 is at the unlocked position 32. As used herein, the relative term ‘forward’ is indicated by an arrow 40 (FIG. 2) and corresponds to the direction that the assembly 10 moves relative to the mating connector 16 when the assembly 10 and the mating connector 16 are in the process of being connected together. Furthermore, as used herein, axial or axially refers to an axis of orientation that corresponds to the in-line connection axis of the wires and connectors and is generally parallel to the arrow 40. In the non-limiting example shown in FIGS. 1-3, a portion of the CPA 30 is shown aligned with the arm 22, but a majority portion of the CPA is indeed located forward of the arm 22 so the CPA does not interfere with operator access to the handle end 26.

Referring now to FIGS. 3 and 4, it may be preferable for the CPA 30 to remain in the unlocked position 32 until the mating connector 16 is actually inserted into the assembly 10. Such a feature is desirable as it avoids, for example, an assembly worker at a vehicle assembly plant having to assure or verify that the CPA 30 is in the unlocked position 32 before attempting to insert the mating connector 16 into the assembly 10. By way of example and not limitation, the CPA 30 may define a notch 42 (FIG. 3) configured to engage with a tab 44 defined by the body 12 to keep the CPA 30 in the unlocked position 32 before a mating connector 16 is inserted into the assembly.

Once the mating connector 16 is fully inserted into the assembly 10, it may be preferable for the CPA 30 to be readily moved forward (direction of arrow 40) to the locked position 38. By way of example and not limitation, the CPA 30 may define a riser 46 configured to cooperate with a bump 48 defined by the mating connector 16 to lift or urge the CPA 30 away from the body 12 and thereby disengage the notch 42 from the tab 44 when the mating connector 16 is inserted into the assembly 10.

Accordingly, an electrical connector assembly (the assembly 10) is provided. The CPA 30 is configured to avoid interfering with access to the handle end 26 of the arm. Such a configuration is particularly important with miniature connectors where the features that need to be operated, accessed, or manipulated by a person disconnecting the assembly 10 from the mating connector are preferably done so without using tools.

While this invention has been described in terms of the preferred embodiments thereof, it is not intended to be so limited, but rather only to the extent set forth in the claims that follow.

1. An electrical connector assembly comprising:
a body;
a lever coupled to the body by an arm, wherein the lever is configured to move about the arm and relative to the body to raise a lock end of the lever when a handle end of the lever is pressed;
a connector position assurance device (CPA) slideably coupled to the lever, said CPA operable between a locked position where the CPA engages with the body to prevent raising of the lock end, and an unlocked position where the lever is allowed to move about the arm, wherein the CPA is located forward of the arm such that the CPA does not obstruct access to the handle end when the CPA is at the unlocked position.

2. The assembly in accordance with claim 1, wherein the CPA defines a notch configured to engage with a tab defined by the body to keep the CPA in the unlocked position before a mating connector is inserted into the assembly.

3. The assembly in accordance with claim 2, wherein the CPA defines a riser configured to cooperate with a bump defined by the mating connector to disengage the notch from the tab when the mating connector is inserted into the assembly.

4. An electrical connector assembly comprising:
a body;
a lever torsionally coupled to the body, wherein the lever is configured to rotate relative to the body to raise a lock end of the lever when a handle end of the lever is pressed; and
a connector position assurance device (CPA) slideably coupled to the lever, said CPA operable between a locked position where the CPA engages with the body to prevent raising of the lock end, and an unlocked position where the lever is moveable relative to the body.

5. The assembly in accordance with claim 4, further comprising an arm, wherein the lever is coupled to the body by an arm, and wherein the CPA is located forward of the arm such that the CPA does not obstruct access to the handle end when the CPA is at the unlocked position.
